(19) United States
(12) Patent Application Publication
(10) Pub. No.: US 2018/0207458 A1
(43) Pub. Date: Jul. 26, 2018

(54) APPARATUS AND METHOD FOR PRODUCING COMPRESSED AIR FOAM FOR FIRE FIGHTING AND FIRE FIGHTING APPARATUS

(71) Applicant: ONE SEVEN MIDDLE EAST SAFETY EQUIPMENTS LLC., Dubai (AE)

(72) Inventor: Dirk SCHMITZ, Abu Dhabi (AE)

(21) Appl. No.: 15/747,019

(22) PCT Filed: Jul. 23, 2015
(86) PCT No.: PCT/IB2015/055582

§ 371 Date: Jan. 23, 2018

(51) Int. Cl. A62C 5/02; B01F 3/04; B01F 5/04; B01F 15/00

(52) U.S. Cl. CPC A62C 5/022; B01F 3/04446; B01F 15/00162; B01F 3/04439; B01F 15/00422; B01F 5/0406

(57) ABSTRACT

The application relates to a method for producing compressed air foam for fire-fighting, wherein the method comprises the following steps: supplying a mixture of water and foaming agent via a supply line (12; 22) in a mixing chamber (11; 21) of a foaming line (10; 20), wherein a regulating device (14; 24) is disposed in the supply line (12; 22), by means of which a volume flow of the mixture can be regulated, suppling compressed air via a compressed air line (13; 23) in the mixing chamber (11; 21), wherein a further regulating device (15; 25) is disposed in the compressed air line (13; 23) by means of which a volume flow of the compressed air can be regulated, producing compressed air foam in the mixing chamber (11; 21) by foaming the mixture of water and foaming agent in the mixing chamber (11; 21) by means of the compressed air and discharging the compressed air foam from the foaming line (10; 20) via a mixing pressure regulator (17; 27) which regulates a mixing pressure in the mixing chamber (11; 21) into a delivery line (30; 40), wherein a pressure measuring device (31; 41) is disposed in the delivery line (30; 40), which records a pressure in the delivery line (30; 40) and which, like the regulating device (14; 24) and the further regulating device (15; 25), couples to the control device (26), and wherein the volume flow of the mixture of water and foaming agent and/or the volume flow of the compressed air is regulated by means of the control device (26) depending on the recorded pressure in the delivery line (30; 40). The application further relates to an apparatus for producing compressed air foam for fire-fighting.

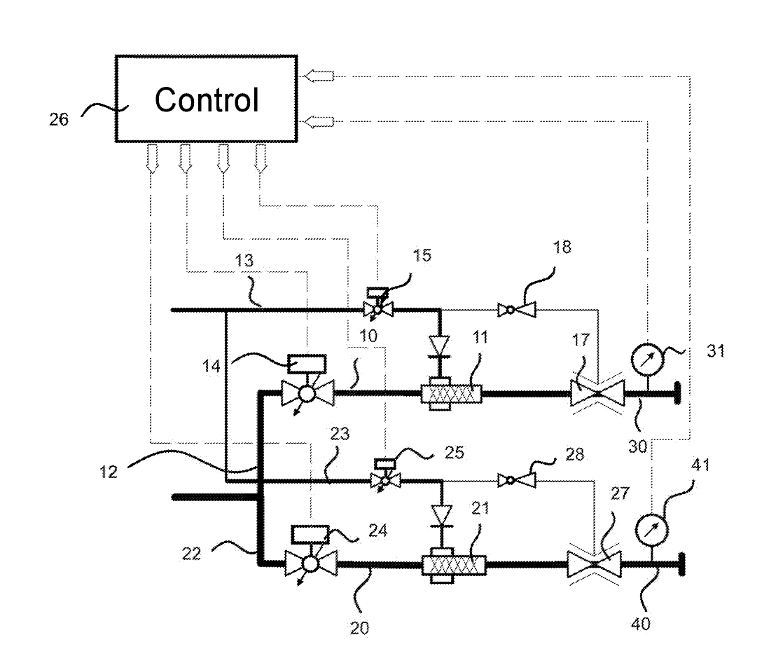

The invention relates to a method and an apparatus for producing compressed air foam for fire-fighting and a fire-fighting apparatus.

### BACKGROUND

It is known to use foams as well as liquids for fire-fighting. A method and an arrangement for producing compressed air foam for fire-fighting are disclosed from the document DE 10 2004 032 020 A1. A mixture of water and foaming agent is introduced into a mixing chamber of a foaming line and is foamed there by means of compressed air. It can be provided to add an additive to the mixture. The compressed air foam produced leaves the foaming line via a mixing pressure control valve and enters into a delivery line from which the compressed air foam is finally used, i.e. in particular for fire-fighting. In order to regulate the mixing or foam pressure in the mixing chamber, i.e. the pressure at which the foaming takes place, in the known apparatus a pressure sensor is disposed in the foaming line between the mixing chamber and the mixing pressure control valve. The pressure in the foaming line is measured by this means. The mixing pressure control valve is regulated depending on the measured pressure.

A control system for a compressed air foam fire extinguishing device is known from the document DE 10 2004 002 112 A1. In the control system a pressure regulation is provided on a pressure side of a compressor for producing compressed air.

The document DE 20 2011 052 455 U1 describes a mixing chamber for producing compressed air foam for extinguishing systems.

An apparatus for producing compressed air foam for fire-fighting is further disclosed in the document U.S. Pat. No. 6,357,532 B1.

### SUMMARY

It is the object of the invention to provide a method and an apparatus for producing compressed air foam for fire-fighting as well as a fire-fighting apparatus by means of which an improved adaptation to different application situations in fire-fighting is made possible.

For the solution a method and an apparatus for producing compressed air foam for fire-fighting are provided according to the independent claims 1 and 10. Furthermore, a fire-fighting apparatus according to claim 11 is proposed. Configurations are the subject matter of independent subclaims.

According to one aspect, a method for producing compressed air foam for fire-fighting is provided. In the method, a mixture of water and foaming agent is supplied via a feed line to a mixing chamber of a foaming line, wherein a regulating device is disposed in the feed line by means of which a volume flow of the mixture can be regulated. Furthermore, compressed air is fed into the mixing chamber via a compressed air line. A further regulating device is disposed in the compressed air line by means of which a volume flow of compressed air can be regulated. In the mixing chamber compressed air foam for fire-fighting is produced by foaming the mixture of water and foaming agent in the mixing chamber by means of the compressed air. The compressed air foam is discharged from the foaming line via a mixing pressure regulator into a delivery line. A mixing pressure in the mixing chamber is regulated by means of the mixing pressure regulator. A pressure measuring device is disposed in the delivery line which records a pressure in the delivery line. The pressure measuring device and also the regulating device and the further regulating device is coupled to a control device. The volume flow of the mixture of water and foaming agent as well as the volume flow of compressed air are regulated by means of the control device as a function of the recorded pressure in the delivery line.

The volume flows are regulated to ensure a foam quality of the compressed air foam produced in the mixing chamber.

The mixture can contain one or more different foaming agents. If desired, an additive different from the foaming agent can be added to the mixture, for example, for decontamination.

According to a further aspect, an apparatus for producing compressed air foam for fire-fighting is provided. The apparatus comprises a foaming line which is formed with a mixing chamber, wherein the mixing chamber is adapted to produce compressed air foam by foaming a mixture of water and foaming agent in the mixing chamber by means of compressed air. A feed line is provided, by means of which the mixture of water and foaming agent can be supplied to the mixing chamber. The compressed air can be supplied to the mixing chamber via a compressed air line. A regulating device is disposed in the feed line and adapted to regulate a volume flow of the mixture. A further regulating device is disposed in the compressed air line and adapted to regulate a volume flow of the compressed air. The foaming line is adjoined via a mixing pressure regulator by a delivery line for discharging the compressed air foam produced. A mixing pressure in the mixing chamber can be regulated by means of the mixing pressure regulator. A pressure measuring device is disposed in the delivery line which is adapted to record a pressure in the delivery line. The apparatus comprises a control device which is coupled to the pressure measuring device as well as the regulating device and the further regulating device. The control device is adapted to regulate the volume flow of the mixture of water and foaming agent as well as the volume flow of compressed air as a function of the recorded pressure in the delivery line.

Furthermore a fire-fighting apparatus is provided with the apparatus for producing compressed air foam. The fire-fighting device can be disposed on a fire-fighting vehicle. Alternatively a stationary design is possible.

By recording the pressure in the delivery line with the aid of the pressure measuring device, it is possible to process the pressure measurement signals and with the aid of the control device, provide control signals for the regulating device in the feed line as well as the further regulating device in the compressed air line in order to adjust the volume flows of mixture and compressed air depending on the measured pressure. The pressure ratios in the delivery line can be very different depending on the specific configuration in the application. One or more nozzles can be provided on the delivery line to discharge the compressed air foam for fire-fighting. Also transverse sections in the delivery line can be configured differently according to the configuration thereof for specific application situations which in turn influences the pressure ratios in the delivery line. Whereas during operation of the apparatus the delivery line is initially more or less emptied, which results in a low pressure in the delivery line, the pressure increases with increasing delivery of compressed air foam produced from the foaming line into the delivery line. If sufficient compressed air foam is subsequently not discharged there again, the pressure in the delivery line increases more and more. This situation can be recorded with the aid of the pressure measuring device in the delivery line in order to reduce the volume flows to the mixing chamber starting from this. If the pressure measured values in the delivery line show a drop, in particular as a result of the discharge of the compressed air foam, the volume flows can be increased (again). In this case, the mixing pressure in the mixing chamber which supports an optimized production of compressed air foam is adjusted with the aid of the mixing pressure regulator located downstream of the mixing chamber, which can be designed as a mixing pressure valve.

The mixing pressure in the mixing chamber can be regulated passively by means of the mixing pressure regulator. A passive regulation can mean in this context that an exit of compressed air foam from the foaming line into the delivery line takes place due to the mixing pressure regulator when the pressure in the foaming line exceeds a limiting pressure which corresponds to the desired mixing pressure. For this purpose the mixing pressure regulator is pre-set to a fixed value. In this embodiment there is no active opening or closing of the mixing pressure regulator to regulate the discharge of foam into the delivery line. On the contrary, the mixing pressure regulator is set and opens when the limiting pressure is exceeded in the foaming line.

The volume flow of the mixture of water and foaming agent can be regulated discontinuously whereby graduated volume flows are set in the delivery line by means of the control device depending on the recorded pressure. For this purpose electronic data relating to the graduated values for the volume flow can be stored in the control device in order to select an assigned volume flow depending on the measured pressure value in the delivery line. The volume flow of the mixture can, for example, be set to graduated values of litres per minute. In one embodiment regulating steps at intervals of 150 to 170 litres/minute can be provided. Thus, an original flow of 500 litres/minute can be reduced to a value of 340 litres/minute in response to the recorded pressure signals in the delivery line.

The volume flow of the compressed air can be discontinuously regulated whereby graduated volume flows are set by means of the control device depending on the recorded pressure in the delivery line. For the volume flow of compressed air, it is also possible to regulate according to predefined values provided in the control device.

Electronic data for various discontinuous regulating configurations for graduated volume flows of the mixture of water and foaming agent and/or compressed air can be provided in the control device, wherein the various discontinuous regulating configurations are assigned to different configurations of the delivery line. Different configurations of the delivery line can, for example, distinguish between the number of nozzles connected to the delivery line. A discontinuous regulating configuration can be assigned to the respective nozzle configuration in the control device for which different graduated volume flows of the mixture and/or the compressed air are assigned. The user of the apparatus can be given the possibility, by means of a user selection, for example, by means of a mechanical selection device such as a lever mechanism or via a menu control on a touch display, to select a configuration for the delivery line so that the control device is accordingly automatically adjusted to this by providing and applying the assigned regulating configuration.

The mixing pressure regulator can be designed with a pneumatically regulated mixing pressure regulator. A compressed air regulated design of the mixing pressure regulator can be provided. For example, a design as a pinch valve can be provided.

The compressed air regulated mixing pressure regulator can be coupled to the compressed air line. The mixing pressure regulator can be connected to the compressed air line via a pressure reducer. Alternatively it can be provided to connect via the pressure reducer to a compressed air system of a fire-fighting vehicle brake system.

The pressure measuring device can be disposed at an output of the mixing pressure regulator or adjacent thereto in the delivery line. In this way the pressure in the delivery line can be recorded adjacent to the output of the mixing pressure valve.

The control device, the pressure measuring device and the regulating devices in the feed line and the compressed air line can be connected to a CAN bus system of a CAN network.

The embodiments explained hereinbefore in connection with the method can be provided accordingly in connection with the apparatus for producing compressed air foam for fire-fighting.

In the method or the apparatus, a plurality of foaming lines with associated delivery lines can be provided. The mixture of water and foaming agent as well as the compressed air can be supplied here via parallel supply lines and compressed air lines. The volume flows in the parallel-operated foaming lines can each be regulated depending on the pressure measured in the associated delivery line. In this way an independent regulation of the parallel foaming lines and delivery lines is possible.

### DESCRIPTION OF EXEMPLARY EMBODIMENTS

Further exemplary embodiments are explained in detail hereinafter with reference to a FIGURE. The FIGURE shows a schematic view of an arrangement for an apparatus for producing compressed air foam for fire-fighting.

The design shown in the figure comprises two foaming lines 10, 20 which can be operated in parallel. Alternatively only one foaming line can be provided (not shown). A mixing chamber 11 is disposed in the foaming line 10. A further mixing chamber 21 is disposed in the further foaming line 20. A mixture containing water and at least one foaming agent is supplied to the mixing chambers 11, 21 via a supply line 12 and a further supply line 22. Compressed air is supplied in the mixing chamber 11 and the further mixing chamber 21 via a compressed air line 13 and a further compressed air line 23.

The volume flow of the mixture containing water and foaming agent can be regulated with the aid of a respective regulating device 14, 24 in the supply line 12, 22, for example by means of a regulating valve. For example, a volume regulating flow is provided. The volume flow of the compressed air can be regulated with the aid of a respective further regulating device 15, 25 in the compressed air line 13, 23. In each case one volume flow regulating valve can be provided.

The regulating device 14, 24 and the further regulating device 15, 25 each couple to a control device 26. The control device 26 in a respective delivery line 30, 40 which adjoins the foaming line 10, 20 via a respective mixing pressure regulator 17, 27 is connected to a respective pressure measuring device 31, 41. The pressure measuring device 31, 41 is adapted to record a pressure in the delivery line 30, 40 in each case. Depending on the measured pressure signals, the volume flows for the mixture comprising water and foaming agent and the compressed air are regulated with the aid of the control device 26. For this purpose corresponding control signals are applied to the regulating device 14, 24 and the further regulating device 15, 25.

The mixing pressure regulators 17, 27 which can be designed as mixing pressure valves, couple to the compressed air line 13, 23 via a respective pressure reducer 18, 28. Alternatively a mixing pressure regulator 17, 27, optionally incorporating pressure reducers, can be coupled to a compressed air braking system of a fire-fighting vehicle if the apparatus is disposed on such a vehicle.

The mixing pressure regulators 17, 27 can thus be set to a desired value by means of pneumatic regulation. If this desired value is exceeded so that a pressure higher than the desired value exists in the foaming line 10, 20, in particular in the mixing chamber 11, 21, the compressed air foam produced in the mixing chamber 11, 21 passes from the foaming line 10, 20 into the delivery line 30, 40. A desired mixing pressure in the respective mixing chamber 11, 21 is maintained with the aid of the mixing pressure regulator 17, 27.

The foam is produced in the mixing chamber 11, 21, for example at a mixing pressure, which is sometimes also designated as foam pressure, of 6 bar. At this pressure the introduced compressed air is still compressed. Nozzles at the delivery line 30, 40 can be dimensioned, for example, so that an input pressure of about 1.5 bar always prevails at the input of the nozzle. This pressure loss from 6 to 1.5 bar is not based exclusively on friction for the compressed air foam during transport in the delivery line 30, 40 but in particular on “decompression”.

For a usual hose line to a nozzle, the fire brigade can usually use hoses having a diameter of 42 mm in the delivery line 30, 40. This then results in a flow of 170 l/min (water fraction in the foam). For a single hose line to a foam generator this is completely unproblematical. However, if the extinguishing attack is made, for example in accordance with FwDv 3 (fire brigade service regulation—three units in extinguishing deployment), initially a hose having a diameter of 75 mm and then a distributor of 3×42 mm is used so that at the end of the delivery line 30, 40, optionally three nozzles must be serviced simultaneously. The 75 mm hose would be sufficient to transport the hose volume of 510 l/min (3×170) so that the delivery could be adjusted to this flow. However it would only function as long as all three connected nozzles are open. If one of the three nozzles is closed, the flow of the two media, mixture and compressed air does not decrease uniformly but results in a pressure rise which in turn hinders the air injection so that the foam becomes very “wet” and no longer possesses the necessary extinguishing properties. If two of the three pipes are closed, the line pressure is so high that no more air can be injected. Here the proposed regulation of the volume flows enables reasonable operation.

The mixing pressure regulator 17, 27 ensures that the foam in the mixing chamber 11, 21 is always produced at the same pressure, for example 6 bar. This is important since one of the media is a compressed gas, namely compressed air, which has different volumes at different pressures. However, if the compressed foam flows through the mixing pressure regulator 17, 27 into the initially empty pipeline in the delivery line 30, 40, it decompresses abruptly since general ambient pressure prevails in the pipe. A slight increase in pressure only occurs here with time and depending on the conveying length and conveying height located therebehind, so that an initial pressure of 2.5 to 4.5 bar is established as long as the output opening (on the nozzle) has a sufficiently large cross-section in order to deliver the foam volume produced. If this is not the case, a pressure rise occurs at this point which lies above half the tolerance limits. This pressure is notified to the control device 26 by means of the pressure measuring devices 31, 41. The control device 26 actuates the regulating device 14, 24 and the further regulating device 15, 25. The regulation can be accomplished for example in steps of 170 l/min so that the flow of 510 l water would be initially reduced to 340 l. If the initial pressure again drops to the desired value, the setting remains but if it drops too far, the original value would be reproduced again since it can be assumed that the one nozzle was only closed briefly.

The features disclosed in the preceding description, the claims and the figure can therefore be important both individually and in any combination for implementing various aspects in their different embodiments.

### REFERENCE LIST

10 Foaming line

11 Mixing chamber

12 Supply line

13 Compressed air line

14, 24 Regulating device

15, 25 Further regulating device

17, 27 Mixing pressure regulator

18, 28 Pressure reducer

20 Further foaming line

21 Further mixing chamber

22 Further supply line

23 Further compressed air line

26 Control device

30, 40 Delivery line

31, 41 Pressure measuring device

1. A method for producing compressed air foam for fire-fighting, wherein the method comprises the following steps:
supplying a mixture of water and foaming agent via a supply line in a mixing chamber of a foaming line, wherein a regulating device is disposed in the supply line, by means of which a volume flow of the mixture can be regulated,
suppling compressed air via a compressed air line in the mixing chamber, wherein a further regulating device is disposed in the compressed air line by means of which a volume flow of the compressed air can be regulated,
producing compressed air foam in the mixing chamber by foaming the mixture of water and foaming agent in the mixing chamber by means of the compressed air and
discharging the compressed air foam from the foaming line via a mixing pressure regulator which regulates a mixing pressure in the mixing chamber into a delivery line,
wherein a pressure measuring device is disposed in the delivery line, which records a pressure in the delivery line and which, like the regulating device and the further regulating device couples to the control device, and wherein the volume flow of the mixture of water and foaming agent and/or the volume flow of the compressed air is regulated by means of the control device depending on the recorded pressure in the delivery line.

2. The method according to claim 1, wherein the mixing pressure in the mixing chamber is regulated passively by means of the mixing pressure regulator.

3. The method according to claim 1, wherein the volume flow of the mixture of water and foaming agent is regulated discontinuously whereby graduated volume flows are set by means of the control device depending on the recorded pressure in the delivery line.

4. The method according to claim 1, wherein the volume flow of the compressed air is regulated discontinuously whereby graduated volume flows are set by means of the control device depending on the recorded pressure in the delivery line.

5. The method according to claim 1, wherein electronic data on various discontinuous regulating configurations for graduated volume flows of the mixture of water and foaming agent and/or compressed air are provided in the control device, wherein the various discontinuous regulating configurations are assigned to different configurations of the delivery line.

6. The method according to claim 1, wherein the mixing pressure regulator is designed with a pneumatically regulated mixing pressure regulator.

7. The method according to claim 6, wherein the compressed air regulated mixing pressure regulator is coupled to the compressed air line.

8. The method according to claim 1, wherein the pressure measuring device is disposed at an output of the mixing pressure regulator or adjacent thereto in the delivery line.

9. The method according to claim 1, wherein the control device, the pressure measuring device and the regulating devices in the supply line and the compressed air line are connected to a CAN bus system of a CAN network.

10. An apparatus for producing compressed air foam for fire-fighting comprising
a foaming line which comprises a mixing chamber, wherein the mixing chamber is adapted to produce compressed air foam whereby a mixture of water and foaming agent is foamed in the mixing chamber by means of the compressed air,
a supply line via which the mixture of water and foaming agent can be supplied to the mixing chamber,
a compressed air line via which compressed air can be supplied to the mixing chamber,
a regulating device which is disposed in the supply line and adapted to regulate a volume flow of the mixture,
a further regulating device which is disposed in the compressed air line and adapted to regulate a volume flow of compressed air,
a delivery line which adjoins a foaming line for discharging the compressed air foam via a mixing pressure regulator which can regulate a mixing pressure in the mixing chamber,
a pressure measuring device which is disposed in the delivery line and is adapted to recorded a pressure in the delivery line and
a control device which couples to the pressure measuring device and the regulating device and the further regulating device and is adapted to regulate the volume flow of the mixture of water and foaming agent and/or the volume flow of the compressed air depending on the recorded pressure in the delivery line.

11. A fire-fighting apparatus having an apparatus for producing compressed air foam according to claim 10, designed as a mobile or stationary fire-fighting apparatus.
